(19) United States
(12) Patent Application Publication
(10) Pub. No.: US 2025/0181843 A1
(43) Pub. Date: Jun. 5, 2025

(54) CONFIGURATION DRIVEN NATURAL LANGUAGE PROCESSING PIPELINE PROVISIONING

(71) Applicant: INTUIT INC., Mountain View, CA (US)

(72) Inventors: Jineet Hiren DOSHI, Mountain View, CA (US); Maya Vered LIVSHITS, Mountain View, CA (US); Pragya TRIPATHI, Mountain View, CA (US)

(73) Assignee: INTUIT INC., Mountain View, CA (US)

(21) Appl. No.: 18/525,545

(22) Filed: Nov. 30, 2023

(51) Int. Cl. G06F 40/40

(52) U.S. Cl. CPC G06F 40/40

(57) ABSTRACT

At least one processor can obtain configuration instructions to direct operations of a natural language processing (NLP) machine learning (ML) pipeline. The configuration instructions can comprise at least one plain-language indicator of at least one NLP operation to be performed by the ML pipeline. The at least one processor can configure the ML pipeline using the configuration file. The at least one processor can perform NLP on text data using the configured ML pipeline.

### BACKGROUND

Natural language processing (NLP) is a field of computing that allows computers and/or other devices to recognize, process, and/or generate natural text resembling human speech and/or writing. NLP can employ rules-based and/or machine learning (ML) algorithms to process text inputs and produce text and/or analytic outputs. Tasks performed by NLP can include, but are not limited to, optical character recognition (OCR), speech recognition, speech segmentation, text-to-speech, word segmentation, tokenization, morphological analysis, syntactic analysis, semantics processing (e.g., lexical semantics processing, relational semantics processing, etc.), text summarization, error (e.g., grammatical error) correction, machine translation, natural language understanding, natural language generation, conversation (e.g., chat bot processing), etc.

Generally, NLP processing is provided by pipelines or other computing environments that are set up and operated by skilled users. Such pipelines can include several operations performed in sequence to deliver a desired output, such as preprocessing and/or inference operations, for example.

Preprocessing for NLP is a common step in many NLP pipelines, as it prepares input data for consumption by NLP models. Preprocessing can be a difficult and time-consuming process involving a variety of tasks such as tokenization, stop word removal, stemming, lemmatization, and part-of-speech tagging. Each of these tasks requires different algorithms and techniques, and the order in which these steps are applied is dependent on the use case. For example, NLP analysis of survey data and NLP analysis of call transcripts might both need removal of stopwords (step reuse). However, the stop words to be removed might be different for the respective use cases. Some NLP steps can be reused across different use cases and teams with different parameters, which could require different coding or model use altogether. In another example, preprocessing can be challenging due to the presence of noisy data, such as special characters, misspellings, and slang. NLP pipelines can be difficult to build and maintain due to the complexity of the tasks involved for preprocessing. Also, the field of NLP is dynamic, and new steps are constantly discovered. All this makes it very challenging for someone without NLP domain knowledge to keep up and leverage state of the art techniques. Moreover, even when NLP pipelines are deployed and maintained by experts, pipeline upkeep and debugging can be enormously compounded by the complexity of the NLP domain, including the preprocessing element of NLP.

### BRIEF DESCRIPTIONS OF THE DRAWINGS

FIG. 1 shows an example machine learning pipeline according to some embodiments of the disclosure.

FIG. 2 shows an example plug and play module according to some embodiments of the disclosure.

FIG. 3 shows an example plug and play configuration process according to some embodiments of the disclosure.

FIG. 4 shows a computing device according to some embodiments of the disclosure.

### DETAILED DESCRIPTION OF SEVERAL EMBODIMENTS

Systems and methods described herein can provide plug and play interpretation of plain language instructions obtained from users to provision and operate NLP pipelines. For example, embodiments described herein can process plain language inputs to a configuration file or other input vector to identify a variety of NLP operations and/or parameters, which may include, but are not limited to, data identification, text preprocessing, model selection and configuration, and output parameters. Embodiments disclosed herein may be optimized for applying configuration file and/or specification-driven processing to NLP domains, making it possible to set up and operate complex ML pipelines using straightforward, reusable, and customizable instructions.

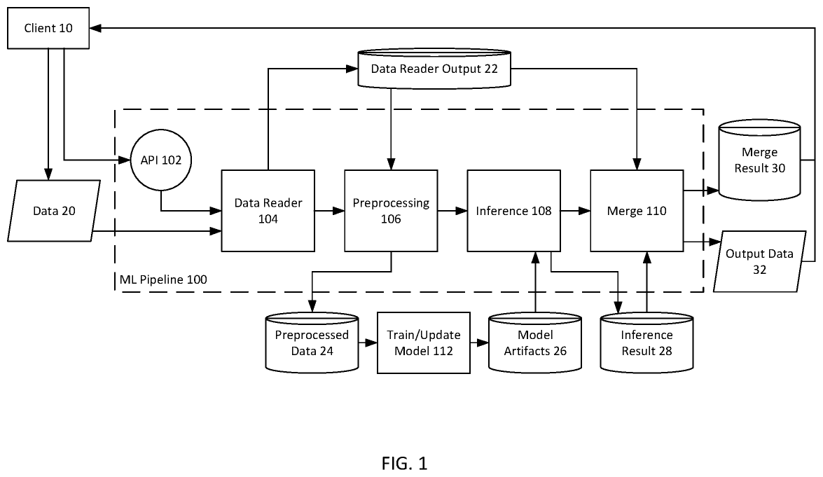

FIG. 1 shows an example ML pipeline 100 according to some embodiments of the disclosure. ML pipeline 100 can be used to train and/or deploy various NLP models over multiple sources of text at scale, while allowing users to reuse code and capabilities from other NLP processing projects, for example.

ML pipeline 100 may be provided by and/or include a variety of hardware, firmware, and/or software components that interact with one another. For example, ML pipeline 100 may include a plurality of processing modules, such as data reader 104, preprocessing 106, inference 108, and merge 110 modules. As described in detail below, these modules can perform processing to select, configure, and execute one or more NLP models to complete NLP tasks. Some embodiments may include a train/update model 112 module which may operate outside of the main ML pipeline 100 to train and/or update any ML model(s) used by ML pipeline 100, including NLP model(s). As described in detail below, ML pipeline 100 may access one or more memories or data stores for reading and/or writing, such as data reader output 22, preprocessed data 24, model artifacts 26, inference result 28, and/or merge result 30. An API 102 may provide access to and/or interaction with ML pipeline 100, for example by one or more client 10 devices. Client 10 can provide and/or indicate data 20 to be processed by ML pipeline 100, and/or one or more instructions for ML pipeline 100 processing. ML pipeline 100 may process data 20 to produce output data 32, which may be provided to client 10, for example.

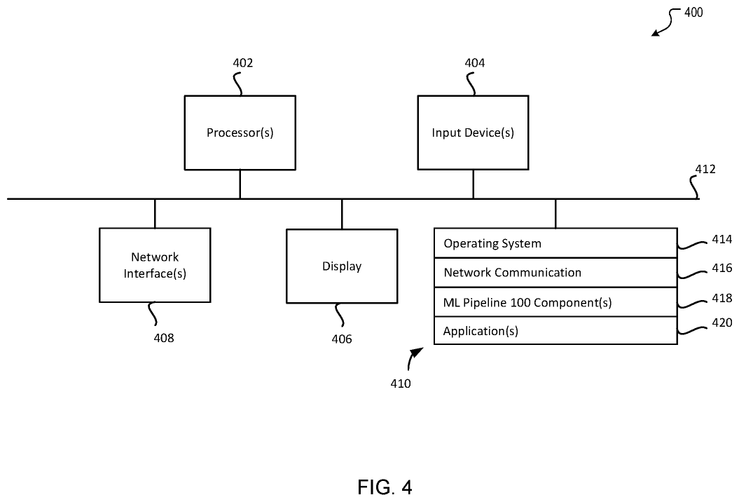

Some components within system 100 may communicate with one another using networks. Some components may communicate with client(s), such as client 10, through one or more networks (e.g., the Internet, an intranet, and/or one or more networks that provide a cloud environment). For example, as described in detail below, client 10 can request data and/or processing from ML pipeline 100, and ML pipeline 100 can provide results to client 10. Each component may be implemented by one or more computers (e.g., as described below with respect to FIG. 4).

Elements illustrated in FIG. 1 (e.g., ML pipeline 100 including data reader 104, preprocessing 106, inference 108, and merge 110 modules, train/update 112 module, data stores 22-30, API 102, and/or client 10) are each depicted as single blocks for ease of illustration, but those of ordinary skill in the art will appreciate that these may be embodied in different forms for different implementations. For example, while ML pipeline 100 and the various modules and data stores are depicted separately, any combination of these elements may be part of a combined hardware, firmware, and/or software element. Likewise, while ML pipeline 100 and its components are depicted as parts of a single system, any combination of these elements may be distributed among multiple logical and/or physical locations. Also, while one of each element (e.g., ML pipeline 100 including data reader 104, preprocessing 106, inference 108, and merge 110 modules, train/update 112 module, data stores 22-30, API 102, and/or client 10) are illustrated, this is for clarity only, and multiples of any of the above elements may be present. In practice, there may be single instances or multiples of any of the illustrated elements, and/or these elements may be combined or co-located.

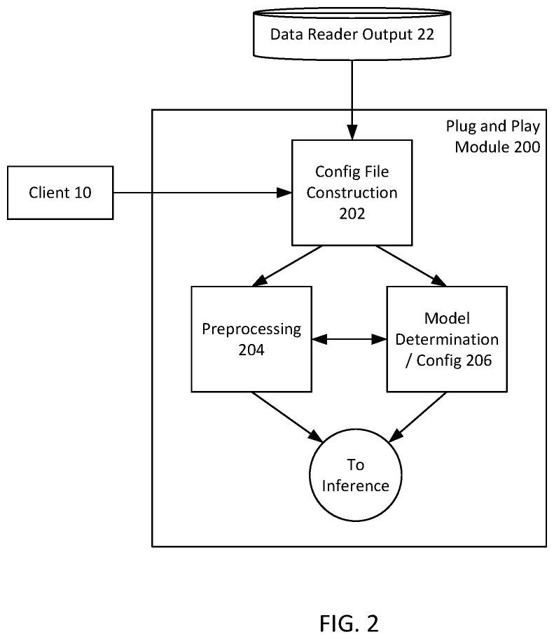

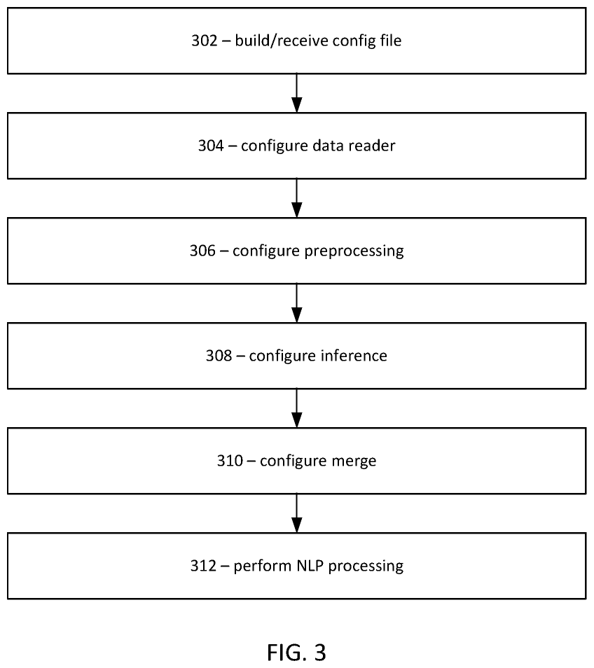

The system of FIG. 1 can perform any number of processes wherein NLP processing is applied to input data to produce a desired result. Within ML pipeline 100, the various modules can perform subsets of such processing that can have unique and/or advantageous features. For example, ML pipeline 100 can include functionality wherein a user (e.g., of client 10) can input a config file having plain language instructions therein, and ML pipeline 100 can interpret those plain language instructions to fully provision and execute ML pipeline 100 NLP actions. This is described in detail below with respect to FIGS. 2 and 3. The following is a description of the overall operation of ML pipeline 100 providing context for understanding the disclosed embodiments.

Client 10 can provide a UI through which a user can enter commands and/or otherwise interact with ML pipeline 100. For example, client 10 can communicate with ML pipeline 100 over a network such as the internet using API 102. API 102 can be an API known to those of ordinary skill in the art and configured for ML pipeline 100 or a novel API developed specifically for ML pipeline 100. In any event, client 10 can provide instructions for processing by ML pipeline 100 and can send data 20 to be processed to ML pipeline 100 and/or indicate a set of data 20 to be processed so that ML pipeline 100 can retrieve and/or access the data 20.

Data reader 104 can obtain and read data 20. Data reader 104 can be configured to ingest data of multiple types (e.g., sql, csv, parquet, json, etc.). Data reader 104 can be configured to perform some level of preprocessing on data 20 in some embodiments, for example filtering out nulls in the data, deduplicating data, etc. Data reader output 22 may be stored in a memory for subsequent processing.

Preprocessing 106 can process data reader output 22. For example, preprocessing 106 can perform plug and play preprocessing, whereby preprocessing options are selected according to user selections received from client 10. In some embodiments, the “plug and play” aspect of the preprocessing can be realized by enabling user selection of a variety of preprocessing options without requiring programming of such options by the user. In some embodiments, a user can add preprocessing commands to, or remove preprocessing commands from, a config file, for example. A UI of client 10 can present the config file for editing and/or present a GUI component for selecting config file edits. In any case, preprocessing 106 can read the config file and determine appropriate processing command(s) based on the content of the config file and the specific NLP model(s) being used in ML pipeline 100, without further input from the user. Preprocessing 106 components and operations are described in greater detail below with reference to FIGS. 2 and 3. Preprocessing 106 can produce a set of preprocessed data 24.

Preprocessed data 24 can be used within the ML pipeline 100 processing and/or to train and/or update one or more ML models. When preprocessed data 24 is being used for training and/or updating, preprocessed data 24 can be applied as input to train/update an ML model 112. The ML model being trained and/or updated can process the preprocessed data 24 according to its algorithm, whether off-the-shelf, known and modified, or custom. Once trained and/or updated, the ML model incorporates the preprocessed data 24 in future processing through the production of model artifacts 26 which can be used in ML pipeline 100 processing, for example during inference 108 processing to perform NLP tasks.

Within ML pipeline 100 processing, inference 108 processing can use preprocessed data 24 and model artifacts 26 to perform NLP tasks as requested by client 10. Inference 108 can select one or more NLP models and apply preprocessed data 24 as input(s) to the selected model(s), thereby producing an inference result 28. In some embodiments, model selection can employ adaptable, reusable hierarchical model inference techniques that can allow users to specify model(s) without supplying code and/or can allow model(s) to reuse configuration and code components as applicable. ML pipeline 100 can be ML framework agnostic so that any models (e.g., topic models, sentiment models, named entity recognition models, etc.) used in any ML frameworks (e.g., PyTorch, TF, Pandas, etc.) may be selected by the config file and used for inference 108 processing.

Depending on the nature of the NLP processing being performed, merge 110 processing can merge data from data reader output 22 and inference result 28 to form a merge result 30 and/or output data 32, which may be provided to client 10 and/or used for other processing.

FIG. 2 is an example plug and play module 200 according to an embodiment of the disclosure. Plug and play module 200 can function as preprocessing 106 module, or a portion thereof, in at least some embodiments of ML pipelines 100. Plug and play module 200 can be configured as a generic, easy to use, and reusable NLP preprocessing module that works with any text data. Plug and play module 200 may be configured to separate out the core functionality of each NLP preprocessing step or option from its parameters, allowing a user to completely specify NLP preprocessing with only basic inputs into a configuration file (or “config file”). For example, plug and play module 200 can perform automated preprocessing with the user only having to input the steps and their order in a declarative way via a config file. Accordingly, users can plug and play different steps along with their respective parameters as they need. Plug and play module 200 therefore can make ML pipeline 100 highly reusable. Plug and play module 200 can also allow users without NLP domain knowledge to access NLP capabilities.

Note that while the example of FIG. 2 uses a config file to obtain and process configuration inputs, other embodiments may use other input vectors. For example, plain-language configuration instructions may be input as direct input parameters into ML pipeline 100, through a UI element, and/or by other techniques. It should be understood that the processing of data obtained from a config file described herein may be used to process data obtained from such other vectors in like fashion. Accordingly, other embodiments may use other configuration instructions that include data such as that included in the config file described in detail below.

Plug and play module 200 can include config file construction processing 202. Config file construction processing 202 can receive input from a user of client 10 and build a config file. For example, the user can use a text editor to insert information into a config file in some embodiments. In other embodiments, config file construction processing 202 and/or client 10 can provide one or more UI elements whereby the user can indicate information to insert into the config file (e.g., by a user-friendly GUI interface with selectable graphic and/or text elements).

In any case, config file construction processing 202 can obtain information defining elements included in a config file. For example, the config file can define one or more processing parameters specifically for NLP operations. These parameters can include, but are not limited to, one or more data source parameters, one or more preprocessing parameters, one or more ML model selections and/or configurations, and/or one or more output parameters. Data source parameters can control and/or modify operations of data reader 104 module. Preprocessing parameters can control and/or modify operations of preprocessing 106 module. ML model selections and/or configurations can control and/or modify operations of inference 108 module. Output parameters can control and/or modify operations of merge 110 module. Accordingly, the config file can define how ML pipeline 100 is to be configured and executed. A user may provision the entire ML pipeline 100 simply by preparing the config file.

The following is an example of at least a portion of a config file according to some embodiments of the disclosure. The specific content of the config file is presented as an example only, but it illustrates how the config file can define an entire ML pipeline 100 operation.
{
   “generic”:
   {
      “version”: “v6”,
      “minor_version”: 0,
      “output_suffix”: “ ”,
      “output_folder”: “midproduct”,
      “id_col”: “primary_id”,
      “pipeline_type”: “inference”,
      “text_col”: “question_response”,
      “timestamp_col_name”: “timestamp_col”,
      “additional_hash_column”: “questionname”
   },
   “data_reader”:
   {
      “source_script”: “midproduct/midproduct_sample.sql”,
      “source_type”: “sql”,
      “filter_blanks”:
      {
         “filter_blanks_needed”: true,
         “col”: “question_response”
      }
   },
   “pre-processing”:
   {
      “extended_stop_words”:
      [
         “year”,
         “years”,
         “turbotax”,
         “turbo”,
         “tax”,
         “re”,
         “get”,
         “got”,
         “go”
         “taxis”,
         “taxes”,
         “n_a”
      ],
      “allowed_pos_tags”:
      [
         “NOUN”,
         “ADJ”,
         “VERB”
      ],
      “spacy_disable”:
      [
         “ner”,
         “parser”
      ],
      “steps”:
      [
         “remove stop words”,
         “lemmatization”,
         “remove regex”,
         “part of speech tagging”
      ],
      “bigrams”:{ }
   },
   “train”:
   { },
   “inference”:
   {
      “model_class”: “SentimentTransformersModellnference”,
      “threshold”: 0.86
   },
   “merge”:
   {
      “schema_name”: “pipeline_output”,
      “table_name”: “mid_product_test_merge”,
      “columns_to_write”: [“product” ]
   }
}

Within the config file, NLP options and/or instructions can be given in plain language. For example, users can input stop words directly, input steps of NLP processing descriptively, input the name of a ML model class, etc. These options and/or instructions need not be coded using programming language or machine language. The above config file snippet includes examples of plain language entries. In the above example config file snippet, some of the headings can be correlated with some of the ML pipeline 100 elements as follows.

Information under the “data reader” heading can define data 20 source location and type and supplies formatting information. This may allow data reader 104 module to locate and intake data 20 by connecting with the given location and extracting the data according to the given data type and formatting parameters.

Information under the “pre-processing” heading can define operations to be performed by preprocessing 106 module to prepare preprocessed data 24 and/or define a work flow and parameters for NLP processing. Preprocessing operations can include defining stop words (e.g., under “extended stop words” sub-heading) and defining allowed part of speech tags (e.g., under “allowed POS tags” sub-heading), as shown in the example above, and/or other operations in other embodiments. NLP flow and parameters can include disabling unwanted features (e.g., under “spacy disable” sub-heading) and specifying and ordering steps in the NLP work flow (e.g., under “steps” sub-heading), as shown in the example above, and/or other features in other embodiments.

Information under the “inference” heading can define ML model(s) to be used by inference 108 module and/or settings thereof. For example, this can include a model class and/or specific model, settings for the model class and/or model (e.g., threshold settings and/or other tunable parameters), as shown in the example above, and/or other features in other embodiments.

Information under the “merge” heading can define data output parameters to be used by merge 110 module to produce merge result 30 and/or output data 32. For example, this can include output destination and/or formatting information, as shown in the example above, and/or other features in other embodiments.

As noted above, while the config file is one possible configuration instruction vector, other embodiments may gather the same data through a UI or direct parameter input to ML pipeline 100. In any case, the following processing may proceed similarly whether the information came from a config file or other input vector.

Plug and play module 200 can include preprocessing 204 and model determination/configuration 206 processing elements. As described in detail below with respect to FIG. 3, preprocessing 204 and model determination/configuration 206 processing elements can use config files from config file construction 202 to perform preprocessing and to provision other elements of ML pipeline 100 to process data 20 as requested by client 10.

FIG. 3 is an example plug and play configuration process 300 according to an embodiment of the disclosure. Plug and play module 200 can perform process 300 to process a config file received from client 10. By processing the config file, plug and play module 200 may perform NLP preprocessing and/or configure ML pipeline 100 to perform NLP on text data 20.

At 302, plug and play module 200 and/or client 10 can build a config file configured to direct operations of ML pipeline 100. Via a user interface of client 10, a user can write a config file and/or use a UI to generate a config file or otherwise input the information. In at least some embodiments, plug and play module 200 can provide instructions for preparing the config file, and/or UI elements, to client 10. As described above, plug and play module 200 can receive data from client 10, resulting in a complete config file being available at plug and play module 200 for subsequent processing. The config file can include at least one plain-language indicator of at least one NLP operation to be performed by ML pipeline 100, non-limiting examples of which are provided above.

At 304, plug and play module 200 can configure data reader 104 processing. Data reader 104 module may need to know where to obtain data 20 and how to access data 20. To that end, plug and play module 200 can read the config file to identify data 20 source information. In the example config file text above, this information is contained under a “data reader” heading. Plug and play module 200 can be configured to read declarative inputs in the config file and translate them to actionable code. For example, plug and play module 200 can include a dictionary defining “data reader” or some other text as an indicator of data 20 source information. Plug and play module 200 can locate the data 20 source information and use it to configure data reader 104 module. Following the example above, plug and play module 200 can configure data reader 104 to access a specific location (e.g., “midproduct/midproduct_sample.sql”) using a specific API and/or protocol (e.g., “sql”) and/or to read data 20 at that location according to one or more formatting rules (e.g., “‘filter_blanks_needed’: true, ‘col’: ‘question_response’”).

At 306, plug and play module 200 can configure preprocessing 106 processing. Plug and play module 200 can read the config file to identify preprocessing information. In the example config file text above, this information is contained under a “pre-processing” heading. Similar to processing at 304, plug and play module 200 can use the dictionary defining “pre-processing” or some other text as an indicator of preprocessing instruction information. Plug and play module 200 can locate the preprocessing instruction information and use it to configure preprocessing 106 module. Following the example above, plug and play module 200 can configure preprocessing 106 to exclude certain stop words, allow certain part of speech tags, and disable certain default features. Plug and play module 200 can also specify the order of such processing, as in some cases the order in which preprocessing is performed can affect the outcome and/or quality of the ML pipeline 100 NLP results.

Configuration of preprocessing 106 may proceed as follows in some embodiments. Plug and play module 200 may be defined in code as a class. In the class, each step can be defined as a method, while the parameters of each step are provided by the user via the config file as noted above. Plug and play module 200 may include code to read the declarative inputs from the config file and execute those specific steps in the provided order with the provided parameters. The order of the steps is provided as a list from the config file, and plug and play module 200 may include a method that loops over the list to ensure execution of steps in order. The steps can be mapped from plain english to method names using a dictionary in the class attributes. Other class attributes can include user provided parameters for the different methods. Such attributes can be provided as lists in the user filled config file. In this way, preprocessing operations specified in plain language may be translated into code for preprocessing text data, which may then be executed in preprocessing 106 when an ML pipeline 100 is run (e.g., at 312 below).

At 308, plug and play module 200 can configure inference 108 module. Plug and play module 200 can read the config file to identify inference information. In the example config file text above, this information is contained under an “inference” heading. Similar to processing at 304 and 306, plug and play module 200 can use the dictionary defining “inference” or some other text as an indicator of inference instruction information. The inference instruction information can identify NLP model(s) or model class(es) to be used in inference 108 processing (e.g., transformer) and, if applicable, NLP parameters or settings thereof (e.g., threshold for 0 or 1 labeling in transformer).

Plug and play module 200 can provide the inference information to inference 108 module. Inference 108 module can identify, load, and configure one or more NLP models as specified in the inference information. In some embodiments, inference information can identify the one or more NLP models according to a hierarchical and extensible language model schema, and inference 108 module can perform processing to identify and configure one or more NLP models according to the schema. For example, inference 108 module may identify at least one plain-language indicator from the inference information within an NLP configuration schema and load NLP model(s) as specified by the schema. In such embodiments, inference information can identify a specific NLP model to be used (e.g., a transformer model configured to perform sentiment analysis, such as BERT or the like). Inference 108 module can identify a base class relevant to the requested NLP model (e.g., from among a plurality of base classes). The base class may have one or more child classes beneath it in the hierarchy, and these child classes may in turn optionally have one or more child classes beneath them, and so on in a hierarchical arrangement. A child class may be a model class representing a single model (e.g., unsupervised topic model) or a family class including a plurality of models (e.g., transformer based models). Along with the functions from the base class interface, a child class can have more functions or parameters specific to the model or family of models. In case of a family class, the class can be extended further to cover a specific model class belonging to the family (e.g., sentiment model can extend transformer model class). Any new model or family of models can be added by extending the appropriate class, whether a base class or a family class representing a family of models lower in the hierarchy. The ML hierarchy schema can arrange a plurality of ML models hierarchically according to model class, such that a base level for a model class defines all artifacts common to the model class, and at least one level below the base level for the model class defines artifacts specific to a particular ML model of the model class. This design makes hierarchical inference module flexible enough to be able to support any current or future language models and makes hierarchical inference module highly reusable. Hierarchical inference module 200 can include code (e.g., infer function) that passes the path to the model class and executes that class, thus running the core inference functions along with model specific logic producing model scores for the input text.

In other embodiments, inference information can include encoded instructions that can be processed directly to load and configure NLP models, and inference 108 module can simply process the instructions provided in the inference information directly. In either case, NLP model(s) may either be available locally or accessed remotely, for example by communicating with at least one ML processing element specified by the inference information and/or schema through at least one API and receiving processing results through the at least one API. In this case, inference 108 module can configure code for communication through the at least one API according to the at least one NLP operation indicated by the inference information (e.g., the at least one plain-language indicator and/or the code).

At 310, plug and play module 200 can configure merge 110 processing. Plug and play module 200 can read the config file to identify merge information. In the example config file text above, this information is contained under a “merge” heading. Similar to processing at 304, 306, and 308, plug and play module 200 can use the dictionary defining “merge” or some other text as an indicator of merge instruction information. The merge instruction information can define how and where the output of inference 108 processing is to be stored (e.g., schema name, table name, columns to include, etc.). Plug and play module 200 can provide the merge information to merge 110 module, which can create merge result 30 and/or output data 32 as prescribed by merge information obtained at 310 upon receiving results from inference 108 module.

At 312, ML pipeline 100 can perform NLP processing as configured. Returning to FIG. 1, data reader 104 can first obtain the data 20 identified at 304 from the location defined at 304. Next, preprocessing 106 can perform the requested preprocessing, in the requested order, as determined at 306. Once preprocessed data 24 is available, inference 108 can run the preprocessed data 24 through the one or more NLP model(s) specified at 308 according to the parameters and/or settings provided at 308 if applicable. Merge 110 module can merge data reader output 22 and inference result 28 to produce merge result 30, and/or provide output data 32, according to the parameters determined at 310. Accordingly, by processing performed by plug and play module 200 described above, ML pipeline 100 has determined at least one ML processing element configured to perform the at least one NLP operation (e.g., preprocessing, inference, and/or merging), loaded the at least one ML processing element into the ML pipeline 100, and performed NLP on text data 20 using the configured ML pipeline 100, including processing by the at least one ML processing element. Client 10 may access merge result 30 and/or output data 32, thereby obtaining results responsive to the config file supplied by a user of client 10 as described above.

FIG. 4 shows a computing device 400 according to some embodiments of the disclosure. For example, computing device 400 may function as a single service 110 or any portion(s) thereof, or multiple computing devices 400 may function as a service 110.

Computing device 400 may be implemented on any electronic device that runs software applications derived from compiled instructions, including without limitation personal computers, servers, smart phones, media players, electronic tablets, game consoles, email devices, etc. In some implementations, computing device 400 may include one or more processors 402, one or more input devices 404, one or more display devices 406, one or more network interfaces 408, and one or more computer-readable mediums 410. Each of these components may be coupled by bus 412, and in some embodiments, these components may be distributed among multiple physical locations and coupled by a network.

Display device 406 may be any known display technology, including but not limited to display devices using Liquid Crystal Display (LCD) or Light Emitting Diode (LED) technology. Processor(s) 402 may use any known processor technology, including but not limited to graphics processors and multi-core processors. Input device 404 may be any known input device technology, including but not limited to a keyboard (including a virtual keyboard), mouse, track ball, and touch-sensitive pad or display. Bus 412 may be any known internal or external bus technology, including but not limited to ISA, EISA, PCI, PCI Express, NuBus, USB, Serial ATA or FireWire. In some embodiments, some or all devices shown as coupled by bus 412 may not be coupled to one another by a physical bus, but by a network connection, for example. Computer-readable medium 410 may be any medium that participates in providing instructions to processor(s) 402 for execution, including without limitation, non-volatile storage media (e.g., optical disks, magnetic disks, flash drives, etc.), or volatile media (e.g., SDRAM, ROM, etc.).

Computer-readable medium 410 may include various instructions 414 for implementing an operating system (e.g., Mac OS®, Windows®, Linux). The operating system may be multi-user, multiprocessing, multitasking, multithreading, real-time, and the like. The operating system may perform basic tasks, including but not limited to: recognizing input from input device 404; sending output to display device 406; keeping track of files and directories on computer-readable medium 410; controlling peripheral devices (e.g., disk drives, printers, etc.) which can be controlled directly or through an I/O controller; and managing traffic on bus 412. Network communications instructions 416 may establish and maintain network connections (e.g., software for implementing communication protocols, such as TCP/IP, HTTP, Ethernet, telephony, etc.).

ML pipeline 100 components 418 may include the system elements and/or the instructions that enable computing device 400 to perform functions of ML pipeline 100 as described above. Application(s) 420 may be an application that uses or implements the outcome of processes described herein and/or other processes. In some embodiments, the various processes may also be implemented in operating system 414.

The described features may be implemented in one or more computer programs that may be executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program may be written in any form of programming language (e.g., Objective-C, Java), including compiled or interpreted languages, and it may be deployed in any form, including as a stand-alone program or as a module, component, subroutine, or other unit suitable for use in a computing environment.

Suitable processors for the execution of a program of instructions may include, by way of example, both general and special purpose microprocessors, and the sole processor or one of multiple processors or cores, of any kind of computer. Generally, a processor may receive instructions and data from a read-only memory or a random access memory or both. The essential elements of a computer may include a processor for executing instructions and one or more memories for storing instructions and data. Generally, a computer may also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data may include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits).

To provide for interaction with a user, the features may be implemented on a computer having a display device such as an LED or LCD monitor for displaying information to the user and a keyboard and a pointing device such as a mouse or a trackball by which the user can provide input to the computer.

The features may be implemented in a computer system that includes a back-end component, such as a data server, or that includes a middleware component, such as an application server or an Internet server, or that includes a front-end component, such as a client computer having a graphical user interface or an Internet browser, or any combination thereof. The components of the system may be connected by any form or medium of digital data communication such as a communication network. Examples of communication networks include, e.g., a telephone network, a LAN, a WAN, and the computers and networks forming the Internet.

The computer system may include clients and servers. A client and server may generally be remote from each other and may typically interact through a network. The relationship of client and server may arise by virtue of computer programs running on the respective computers and having a client-server relationship to each other.

One or more features or steps of the disclosed embodiments may be implemented using an API and/or SDK, in addition to those functions specifically described above as being implemented using an API and/or SDK. An API may define one or more parameters that are passed between a calling application and other software code (e.g., an operating system, library routine, function) that provides a service, that provides data, or that performs an operation or a computation. SDKs can include APIs (or multiple APIs), integrated development environments (IDEs), documentation, libraries, code samples, and other utilities.

The API and/or SDK may be implemented as one or more calls in program code that send or receive one or more parameters through a parameter list or other structure based on a call convention defined in an API and/or SDK specification document. A parameter may be a constant, a key, a data structure, an object, an object class, a variable, a data type, a pointer, an array, a list, or another call. API and/or SDK calls and parameters may be implemented in any programming language. The programming language may define the vocabulary and calling convention that a programmer will employ to access functions supporting the API and/or SDK.

In some implementations, an API and/or SDK call may report to an application the capabilities of a device running the application, such as input capability, output capability, processing capability, power capability, communications capability, etc.

While various embodiments have been described above, it should be understood that they have been presented by way of example and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. For example, other steps may be provided, or steps may be eliminated, from the described flows, and other components may be added to, or removed from, the described systems. Accordingly, other implementations are within the scope of the following claims.

In addition, it should be understood that any figures which highlight the functionality and advantages are presented for example purposes only. The disclosed methodology and system are each sufficiently flexible and configurable such that they may be utilized in ways other than that shown.

Although the term “at least one” may often be used in the specification, claims and drawings, the terms “a”, “an”, “the”, “said”, etc. also signify “at least one” or “the at least one” in the specification, claims and drawings.

Finally, it is the applicant's intent that only claims that include the express language “means for” or “step for” be interpreted under 35 U.S.C. 112(f). Claims that do not expressly include the phrase “means for” or “step for” are not to be interpreted under 35 U.S.C. 112(f).

What is claimed is:

1. A method comprising:
obtaining, by at least one processor, a configuration instruction configured to direct operations of a natural language processing (NLP) machine learning (ML) pipeline, the configuration instruction comprising at least one plain-language indicator of at least one NLP operation to be performed by the ML pipeline;
configuring, by the at least one processor, the ML pipeline using the configuration instruction, the configuring comprising:
determining at least one ML processing element configured to perform the at least one NLP operation, and
loading the at least one ML processing element into the ML pipeline; and
performing, by the at least one processor, NLP on text data using the configured ML pipeline, the NLP including processing by the at least one ML processing element.

2. The method of claim 1, wherein the determining comprises identifying the at least one plain-language indicator within an NLP configuration schema.

3. The method of claim 1, wherein the loading and the NLP are facilitated by communicating, by the at least one processor, with the at least one ML processing element through at least one application programming interface (API).

4. The method of claim 3, wherein the loading comprises configuring code for communication through the at least one API according to the at least one NLP operation indicated by the at least one plain-language indicator.

5. The method of claim 1, wherein the at least one plain-language indicator further defines at least one NLP parameter for the at least one NLP operation.

6. The method of claim 5, wherein the loading comprises configuring the at least one ML processing element to perform the NLP according to the at least one NLP parameter.

7. The method of claim 5, wherein the NLP comprises processing the text data according to the at least one NLP parameter.

8. A method comprising:
obtaining, by at least one processor, a configuration instruction configured to direct operations of a natural language processing (NLP) machine learning (ML) pipeline, the configuration instruction comprising at least one plain-language indicator of at least one NLP operation to be performed by the ML pipeline;
configuring, by the at least one processor, the ML pipeline using the configuration instruction, the configuring comprising translating the at least one plain-language indicator into code configured to perform the at least one NLP operation; and
performing, by the at least one processor, NLP on text data using the configured ML pipeline, the NLP including executing the code.

9. The method of claim 8, wherein the configuring comprises identifying the at least one plain-language indicator within an NLP configuration schema.

10. The method of claim 8, wherein the configuring and the NLP are facilitated by communicating, by the at least one processor, with the at least one ML processing element through at least one application programming interface (API).

11. The method of claim 10, wherein the code comprises code for communication through the at least one API according to the at least one NLP operation indicated by the at least one plain-language indicator.

12. The method of claim 8, wherein the at least one plain-language indicator further defines at least one NLP parameter for the at least one NLP operation.

13. The method of claim 12, wherein the code is configured to perform the NLP according to the at least one NLP parameter.

14. The method of claim 12, wherein the NLP comprises processing the text data according to the at least one NLP parameter.

15. A system comprising:
at least one processor; and
at least one non-transitory computer-readable memory storing instructions that, when executed by the at least one processor, cause the at least one processor to perform processing comprising:
obtaining a configuration instruction configured to direct operations of a natural language processing (NLP) machine learning (ML) pipeline, the configuration instruction comprising at least one plain-language indicator of at least one NLP operation to be performed by the ML pipeline;
configuring the ML pipeline using the configuration instruction, the configuring comprising at least one of:
determining at least one ML processing element configured to perform the at least one NLP operation and loading the at least one ML processing element into the ML pipeline, and
translating the at least one plain-language indicator into code configured to perform the at least one NLP operation; and
performing NLP on text data using the configured ML pipeline, the NLP including at least one of processing by the at least one ML processing element and executing the code.

16. The system of claim 15, wherein the configuring comprises identifying the at least one plain-language indicator within an NLP configuration schema.

17. The system of claim 15, wherein the configuring and the NLP are facilitated by communicating, by the at least one processor, with the at least one ML processing element through at least one application programming interface (API).

18. The system of claim 15, wherein the at least one plain-language indicator further defines at least one NLP parameter for the at least one NLP operation.

19. The system of claim 18, wherein at least one of the code and the at least one ML processing element is configured to perform the NLP according to the at least one NLP parameter.

20. The system of claim 18, wherein the NLP comprises processing the text data according to the at least one NLP parameter.
